(19) United States
(12) Patent Application Publication
(10) Pub. No.: US 2015/0187283 A1
(43) Pub. Date: Jul. 2, 2015

(54) METHOD AND APPARATUS FOR SELECTIVELY ADJUSTING BRIGHTNESS OF A DISPLAY

(71) Applicant: Google Technology Holdings LLC, Mountain View, CA (US)

(72) Inventors: Jun Jiang, Lake Zurich, IL (US); XiaoPing Bai, Lake Zurich, IL (US)

(73) Assignee: Google Technology Holdings LLC, Mountain View, CA (US)

(21) Appl. No.: 14/140,624

(22) Filed: Dec. 26, 2013

(51) Int. Cl. G09G 3/34

(52) U.S. Cl. CPC G09G 3/3406; G09G 2320/0646; G09G 2320/0626; G09G 2320/0693

(57) ABSTRACT

A method and apparatus for adjusting transmittance for a display of an electronic device based on brightness produced by a backlighting source for the display includes measuring, at each location of a plurality of locations on the display, a brightness level produced by the backlighting source during operation of the electronic device, using a sensor at each location. The method also includes determining, based on the measured brightness levels, a plurality of transmittance values each specifying a transmittance for a different area of multiple areas of the display, and electronically setting transmittance for each area of the multiple areas of the display using the plurality of transmittance values. Additionally, a method for adjusting the backlighting source includes turning off lighting elements of the backlighting source for an unused portion of the display and reducing luminosities of lighting elements of the backlighting source for a used portion of the display.

### FIELD OF THE DISCLOSURE

The present disclosure relates generally to adjusting backlighting brightness for a display and more particularly to adjusting luminosities and transmittances for a display.

### BACKGROUND

The display serves as a centerpiece for modern-day mobile electronic devices. As electronics, such as smartphones, phablets, and tablets, continue to evolve through increasing levels of performance and functionality, so have their displays to allow for their effective operation. Increasingly, mechanical controls are giving way to touch-sensitive displays. Larger, high-resolution displays allow devices to simultaneously present a user with a greater number of controls for immediate access to specific functions. Users also favor larger displays with higher resolutions for multimedia applications that are now being integrated into a large number of electronic devices.

With larger, high-resolution displays comes a greater number of lighting elements used to illuminate the displays. These lighting elements serve as the largest power drain for many mobile devices, and by using more of them, finding ways to prolong battery life becomes an important consideration. Additionally, with the use of a greater number of lighting elements, it is statistically more likely that one or more of them will provide insufficient illumination, or possibly no illumination at all. This causes localized dimness for areas of the display. Manufacturing defects in a display, damage sustained by a display after manufacture, or the breakdown of components within a display due to age, can all result in non-uniform illumination for the display, degrading the image quality for the display.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of an electronic device in accordance with some embodiments of the present teachings.

FIG. 2 is a block diagram of some internal elements of an electronic device configured for implementing some embodiments of the present teachings.

FIG. 3 is a block diagram illustrating multiple layers of a display in accordance with some embodiments of the present teachings.

FIG. 4 is a schematic diagram illustrating two types of backlighting sources for a display in accordance with some embodiments of the present teachings.

FIG. 5 is a logical flow diagram illustrating a method for adjusting transmittance for a display in accordance with some embodiments of the present teachings.

FIG. 6 is a pair of schematic diagrams illustrating screening elements for an area of a display in accordance with some embodiments of the present teachings.

FIG. 7 is a sequence of schematic diagrams illustrating a method for adjusting screening elements of a display in accordance with some embodiments of the present teachings.

FIG. 8 is a pair of schematic diagrams illustrating adjusting screening elements of a display in accordance with some embodiments of the present teachings.

FIG. 9 is a logical flow diagram illustrating a method for adjusting luminosity and transmittance for a display in accordance with some embodiments of the present teachings.

FIG. 10 is a logical diagram illustrating a method for adjusting luminosity and transmittance for a display in accordance with some embodiments of the present teachings.

FIG. 11 is a logical flow diagram illustrating a method for adjusting backlighting for a display in accordance with some embodiments of the present teachings.

FIG. 12 is a schematic diagram illustrating adjusting lighting elements of a backlighting source in accordance with some embodiments of the present teachings.

FIG. 13 is a schematic diagram illustrating adjusting lighting elements of a backlighting source in accordance with some embodiments of the present teachings.

FIG. 14 is a schematic diagram illustrating adjusting lighting elements of a backlighting source in accordance with some embodiments of the present teachings.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Generally speaking, pursuant to the various embodiments, the present disclosure provides a method and apparatus for adjusting backlighting brightness for a display of an electronic device. In accordance with the teachings herein, a method performed by an electronic device for adjusting transmittance for a display of the electronic device based on brightness produced by a backlighting source for the display includes measuring, at each location of a plurality of locations on the display, a brightness level produced by the backlighting source during operation of the electronic device, wherein the measuring is performed by a sensor at that location. The method further includes determining, based on the measured brightness levels, a plurality of transmittance values each specifying a transmittance for a different area of multiple areas of the display, and electronically setting transmittance for each area of the multiple areas of the display using the plurality of transmittance values.

Also in accordance with the teachings herein, a method performed by an electronic device for adjusting a backlighting source for a display of the electronic device includes turning off lighting elements of the backlighting source for an unused portion of the display. The method also includes reducing luminosities of lighting elements of the backlighting source for a used portion of the display.

Further in accordance with the teachings herein is an electronic device configured to adjust transmittance for a display based on brightness produced by a backlighting source for the display. The electronic device includes a display configured to display images, wherein the display includes: a plurality of lighting elements configured to provide backlighting for the display; a plurality of photosensors, wherein each photosensor is configured to measure a brightness level at a different location on the display during operation of the electronic device; and a plurality of screening elements, wherein each screening element is configured to selectively screen the backlighting for a different area of multiple areas of the display based on a transmittance value for the screening element. Also included in the electronic device is a processing element coupled to the plurality of photosensors, wherein the processing element is configured to determine, based on the measured brightness levels, a plurality of transmittance values and to communicate the plurality of transmittance values to a display controller. The electronic device further includes the display controller coupled to the plurality of screening elements and the processing element, wherein the display controller is configured to receive the plurality of transmittance values from the processing element and to electronically set the transmittance for each screening element of the plurality of screening elements based on the plurality of transmittance values.

In one embodiment, the multiple areas of the display are configured so that each area comprises a single screening element of the plurality of screening elements, wherein the transmittance value for each screening element is determined independently from the transmittance values for the other screening elements or each area comprises multiple screening elements, wherein the multiple screening elements for the area are determined to have the same transmittance value.

In another embodiment, the processing element is further configured to determine, based on the measured brightness levels, a set of luminosity adjustment values and to communicate the set of luminosity adjustment values to the display controller. Additionally, the display controller is further coupled to the plurality of lighting elements and is further configured to adjust a luminosity of at least one lighting element of the plurality of lighting elements based on the set of luminosity adjustment values.

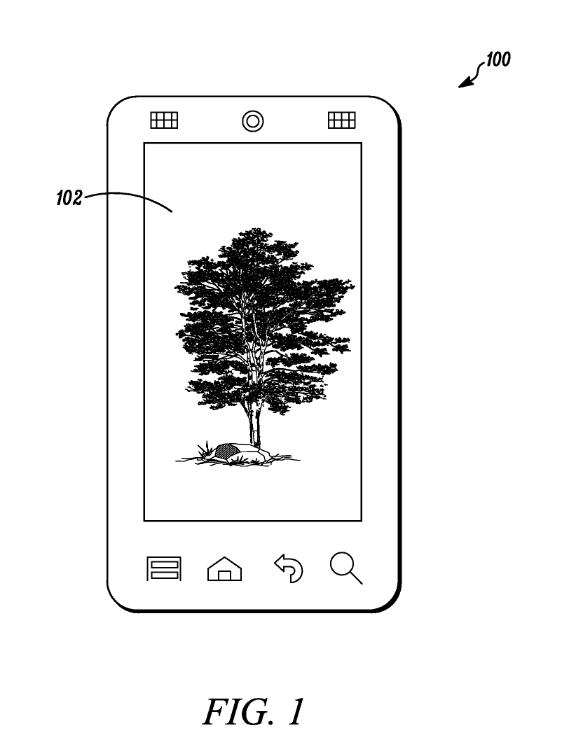

Referring now to the drawings, and in particular FIG. 1, an electronic device (also referred to herein simply as a “device”) implementing embodiments in accordance with the present teachings is shown and indicated generally at 100. Specifically, device 100 represents a smartphone that has a visual display 102 (also referred to herein simply as a “display”) configured to display images to a user of the device 100. While a smartphone is shown at 100, no such restriction is intended or implied as to the type of device to which these teachings may be applied. Other suitable devices include, but are not limited to: phablets; tablets; personal digital assistants (PDAs); portable media players (e.g., MP3 players); electronic book readers; personal global-positioning-system (GPS) receivers; wearable electronic devices, such as devices worn with a wristband; cameras; camcorders; displays for computerized machinery (e.g., computer numerical control (CNC) machines and automobiles); automated teller machines (ATMs); kiosk terminals; and vending machines. For purposes of these teachings, an electronic device can be any device that includes an illuminable display.

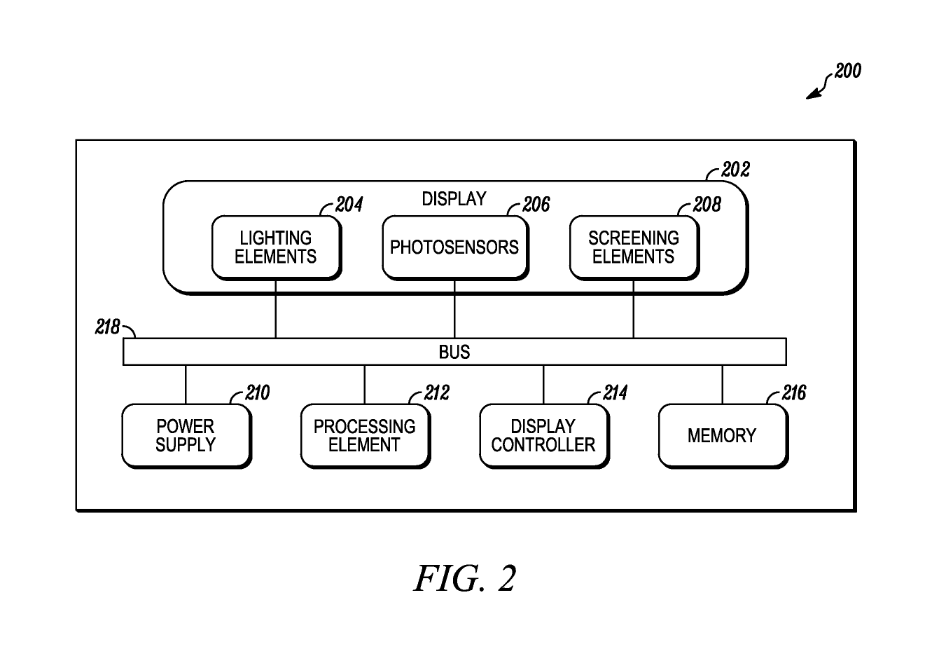

Referring to FIG. 2, a block diagram illustrating some internal elements of an electronic device in accordance with embodiments of the present teachings is shown and indicated generally at 200. For one embodiment, the block diagram 200 represents some of the internal elements of the device 100. Specifically, the block diagram 200 shows: a display 202 that includes lighting elements 204, photosensors 206, and screening elements 208; a power supply 210; a processing element 212; a display controller 214; and memory 216, which are all operationally interconnected by a bus 218.

A limited number of device elements 202, 204, 206, 208, 210, 212, 214, 216, 218 are shown at 200 for ease of illustration, but other embodiments may include a lesser or greater number of such elements in a device. Moreover, other elements needed for a commercial embodiment of a device that incorporates the elements shown at 200 are omitted from FIG. 2 for clarity in describing the enclosed embodiments.

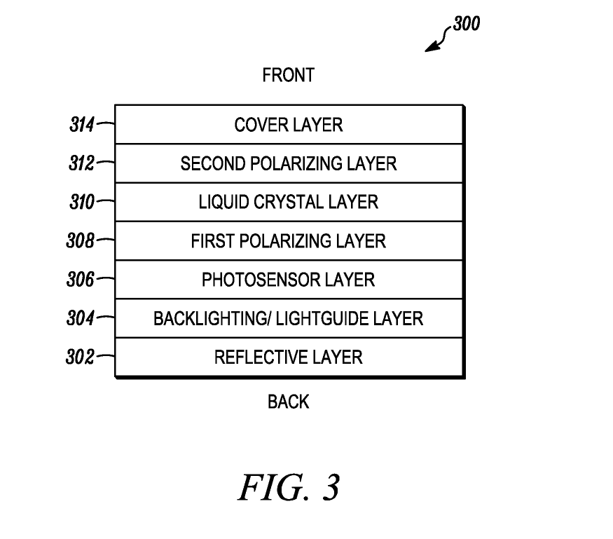

We turn now to a brief description of the device elements shown in the block diagram 200. In general, the lighting elements 204, the photosensors 206, and the screening elements 208 of the display 202, in addition to the display controller 214 and the processing element 212 are configured with functionality in accordance with embodiments of the present disclosure as described in detail below with respect to the remaining FIGS. 3-14. “Adapted,” “operative” or “configured,” as used herein, means that the indicated elements are implemented using one or more hardware devices such as one or more operatively coupled processing cores, memory elements, and interfaces, which may or may not be programmed with software and/or firmware as the means for the indicated elements to implement their desired functionality. Such functionality is supported by the other hardware shown in FIG. 2, including the device elements 210, 216, and 218.

Continuing with the brief description of the device elements shown at 200, as included within the electronic device 102, the lighting elements 204 of the display 202 are a plurality of elements, each of which is capable of generating light to illuminate the display 202. The lighting elements 204 provide the display 202 with an internal light source, making an external light source unnecessary to view the display 202. In a particular embodiment, the lighting elements 204 are integrated into a backlighting module for the display 202. For purposes of these teachings, a lighting element is any individual element of the plurality of lighting elements 204 that forms part of the display 202 and is capable of providing illumination to the display 202. In a particular embodiment that includes a liquid crystal display (LCD) panel, the lighting elements 204 are light emitting diodes (LEDs) that provide backlighting for the display panel. In other embodiments, lighting elements include, but are not limited to: cold cathode fluorescent lamps (CCFLs); electroluminescent films; and incandescent lamps.

Each of the lighting elements 204 has a luminosity that adds to a brightness level of the display 202. As used herein, a luminosity of a lighting element is a quantitative measure of the instantaneous light output of the lighting element. Equivalently, a luminosity of a lighting element represents a flux of light energy (electromagnetic energy in the visible spectrum) passing through a hypothetical closed surface surrounding the lighting element. A luminosity level refers to a particular quantitative value for the luminosity of a lighting element. A brightness level of a display is a function of position, and as used herein, represents a quantitative measure of the instantaneous light energy density that exists at a position on the display 202. Where luminosity is the total light output of a single lighting element integrated over all directions, a brightness level is a cumulative effect of light energy radiated from all the lighting elements that reaches (either directly or indirectly, such as by reflection) a single point on the display 202.

Brightness levels are measured at various positions on the display 202 using the photosensors 206. Each photosensor of the plurality of photosensors 206 is positioned at a location on the display 202 and measures the brightness level at that location. For different embodiments, devices used as photosensors include, but are not limited to: photodiodes; bipolar phototransistors; photosensitive field-effect transistors (FET); charge-coupled devices (CCDs); reverse-biased LEDs; photoresistors; and other types of photosensitive semiconductor devices.

Screening elements 208 within the display 202 control the amount of light radiating from the lighting elements 204 that reaches the viewable surface of the display 202. As used herein, each screening element of the plurality of screening elements 208 selectively screens or blocks a portion of the light radiating from the lighting elements 204 from reaching the portion of the viewable surface of the display 202 at which the screening element is located. For an embodiment, a transmittance for each of the screening elements 208 is set individually of the others to a transmittance value, which represents a particular quantitative measure of the screening element's ability to pass light.

The transmittance of a screening element for a particular portion of the display 202 can be set so that the screening element is completely transparent, allowing all light incident upon the screening element to pass through it to the surface of the display 202, or the transmittance can be set so that the screening element is completely opaque, blocking all light incident upon the screening element from reaching the surface of the display 202. The transparency of screening elements 208 can also be set using transmittance values that make them semi-transparent or semi-opaque, which means that some, but not all, of the light incident upon the screening elements 208 is allowed to reach the viewable surface of the display 202. For one embodiment, the transparency of the screening elements 208 is adjusted incrementally in discrete steps by using a relatively small number (e.g., 16) of transmittance values. For another embodiment, the transparency of the screening elements 208 is adjusted almost continuously by using a relatively large number (e.g., 256) of transmittance values.

Turning momentarily to FIG. 3, a block diagram representing a display of an electronic device consistent with embodiments of the present teachings is shown and indicated generally at 300. In the embodiment shown, the display is a liquid-crystal (LC) display, and each of the plurality of screening elements includes a polarizing element. A polarizing element, as used herein, is an optical filter that passes light based on the light's polarization, which is the orientation of its electric field. For described embodiments, the display 300 represents the display 202. The block diagram 300 shows individual layers of the display 202 and how those layers combine to allow the display 202 to perform its intended functionality. Specifically, beginning at the back of the display 202 shown at the bottom of the diagram 300, which is closest to a back (not shown) of the electronic device 102, the layers include: a reflective layer 302; a backlighting layer 304 that can include a lightguide; a photosensor layer 306; a first polarizing layer 308; an LC layer 310; a second polarizing layer 312; and a cover layer 314. While seven specific layers are shown at 300, alternative embodiments include different, e.g., fewer or additional layers for the display of an electronic device.

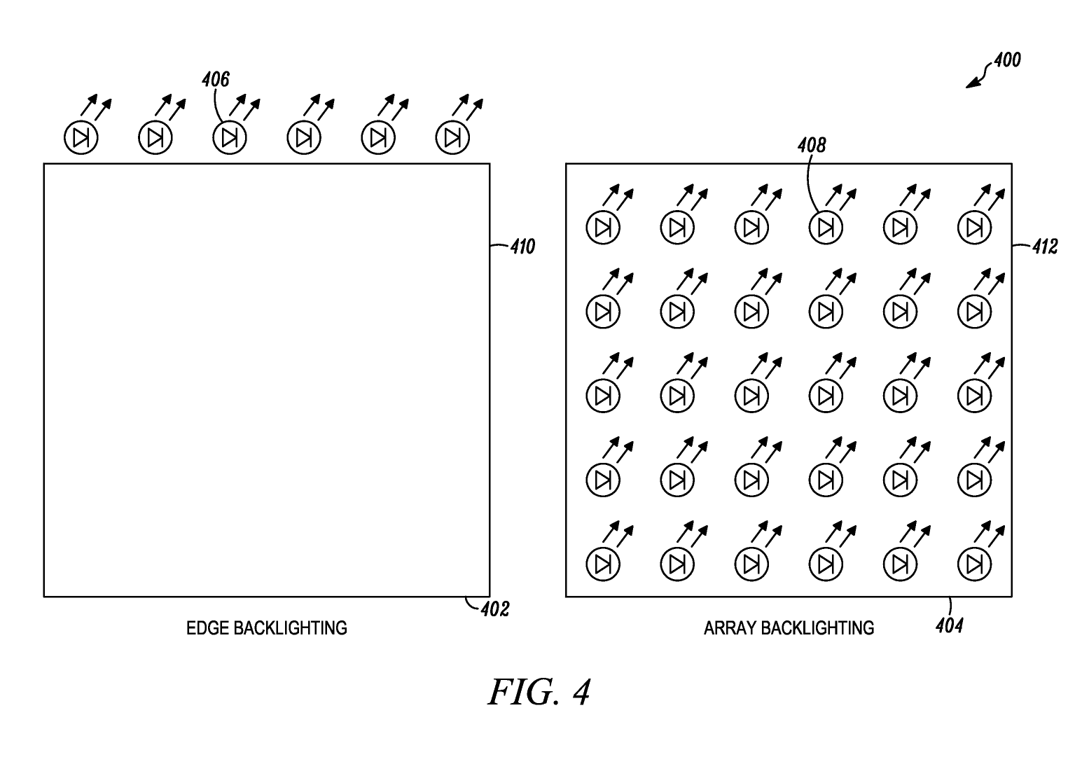

The backlighting layer 304 includes the lighting elements 204 that illuminate the display 202. Within the backlighting layer 304, the lighting elements 204 may be arranged in different ways. A more detailed description of the arrangement of the backlighting elements 204 is provided with reference to FIG. 4. FIG. 4, at 400, shows two specific arrangements for the backlighting elements 204 that are consistent with embodiments of the present teachings, an edge backlighting arrangement 402 and an array backlighting arrangement 404. For each of the illustrated arrangements 402, 404, a rectangle 410, 412 represents a viewable area of the display 202 illuminated by the backlighting. The edge backlighting arrangement 402 represents a first type of arrangement for the lighting elements 204 within the backlighting layer 304. For an edge-lit display, LEDs 406 are placed along an edge of the display 202, as shown. To illuminate the entire display area 410 from the edge, a lightguide (not shown) is used to direct light radiated from the LEDs 406 across the display area 410.

A layer 304 of transparent material forms the lightguide. Light from the LEDs 406 enters the lightguide and is propagated across the display 402 within the lightguide. As a light ray within the lightguide is incident upon the upper surface of the lightguide, at an angle that is not normal to the surface of the lightguide, a portion of the light ray is refracted through the upper surface of the lightguide and go on to illuminate the display, while the remaining portion of the light ray is reflected internally and continue to propagate through the lightguide until it is again incident upon its upper surface. Adjusting the ratio of refracted light to reflected light is done by selecting a specific index of refraction for transparent material forming the lightguide, using optical coatings on the lightguide, and/or controlling the geometry of the upper surface of the lightguide.

In additional embodiments that use edge backlighting, the lighting elements 406 are arranged along different and/or additional edges of the display 410. In a particular embodiment, the lighting elements 406 are located along two opposing edges of the display 410. While six LEDs are shown at 406, other embodiments may include a greater or lesser number of such lighting elements 204.

Array backlighting, shown at 404, is a second type of backlighting that is consistent with the teachings herein. For array backlighting, LEDs 408, which represent the lighting elements 204, are distributed throughout the viewable area 412 of the display 202 within the backlighting layer 304. For array backlighting, the entire viewable area 412 of the display 202 can be illuminated directly by the backlighting LEDs 408, each point being illuminated primarily by the nearest of the LEDs 408. This eliminates the need for a lightguide.

Returning to FIG. 3, the reflective layer 302, which is shown underneath the backlighting layer 304, prevents light from the backlighting layer 304 from leaking out of the backside of the display 202. By reflecting light back into the lightguide from underneath, all or substantially all the light radiating from the lighting elements 204 is eventually directed toward the front of the display 202, through the photosensor layer 306, making the most efficient use of available light.

The photosensors 206 are located in the photosensor layer 306. Different embodiments have different numbers of photosensors 206 and different spatial arrangements for the photosensors 206. Each photosensor 206 measures a brightness level produced by the lighting elements 204 at the location of the photosensor 206. Using a plurality of photosensors 206 results in a determination of a plurality of different brightness levels measured at different positions on the display 202. The plurality of measured brightness levels, in turn, provide information on the status of the lighting elements 204 and the illumination they provide.

Ideally, each lighting element is operating optimally in accordance with its design specifications so that the plurality of lighting elements 204 provides uniform lighting over the entire viewable area of the display 202. In reality, however, lighting conditions oftentimes vary from this ideal. Seemingly identical lighting elements can have different light outputs for a variety of reasons. These reasons can include, but are not limited to: process variations and/or defects in the manufacturing of the lighting elements 204; physical damage sustained by the lighting elements 204; decreasing performance of the lighting elements 204 due to age; broken or damaged connections with the lighting elements 204; and/or differences in how the lighting elements 204 are placed within the backlighting layer 304 in terms of nearby materials that block, reflect, absorb, or otherwise affect light radiating from the lighting elements 204.

It may be the case, for example, that one lighting element 204 is functioning at a greatly reduced efficiency (e.g., 40%) while another lighting element is not functioning at all (e.g., 0%). This is in addition to relatively small statistical variations in the light output among the remaining lighting elements 204. This results in noticeably dim areas on the display 202 where the backlighting is insufficient. Alternatively, other areas of the display 202 might be overly bright. Areas on the display 202 where the actual amount of light varies from the optimal amount of light are detected by the photosensors 206.

For array backlighting, one distribution of photosensors 206 in the photosensor layer 306 places a photosensor 206 above each of the lighting elements 204. This allows for monitoring individual lighting elements 204 directly. In practice, however, a one-to-one correspondence between lighting elements 204 and photosensors 206 is unnecessary when using array backlighting as the same result is accomplished using fewer photosensors 206 than lighting elements 204. This reduces manufacturing costs and the amount of light that is obstructed by the photosensors 206.

For edge backlighting, fewer lighting elements 204 are used as compared to the number of lighting elements 204 used for array backlighting. Therefore, the relative number of photosensors 206 used in proportion to the number of lighting elements 204 for edge lighting is usually greater as compared to array lighting. For one embodiment, the number of photosensors 206 equals the number of lighting elements 204. For another embodiment, the display 102 includes more photosensors 206 than lighting elements 204. In a particular embodiment for edge lighting where the number of photosensors 206 exceeds the number of lighting elements 204, the display 102 is divided into zones that each include a photosensor. In this embodiment, the predictable nature of how the lighting elements 204 illuminate the display 102 is used to determine how the display 102 is divided into zones and where, within each zone, a photosensor is placed. For both array backlighting and edge backlighting, a plurality of brightness levels measured by the photosensors 206 are compiled to determine a brightness distribution for the display 202 to identify which portions of the display 202 and/or which of the lighting elements 204, are insufficiently lit.

As used herein, a brightness distribution for a display compiled from brightness levels measured by photosensors at different locations on the display of a device is a construct used by a processing element of the device to deduce or infer a current status for backlighting of the display, and more particularly how the current status differs from an ideal status for backlighting of the display. For example, an ideal status for backlighting of a display is a uniform illumination of the entire viewable area of the display, but the current status for backlighting of the display is that the illumination of the upper-left corner of the display is weaker than the illumination for the rest of the display. In one embodiment, a brightness distribution refers simply to a set of measured brightness levels for a display, which may be tabulated in a particular order. In another embodiment, a device determining a brightness distribution involves the device processing measured brightness levels beyond their mere tabulation to better facilitate an identification of portions of the display and/or lighting elements within the display that are insufficiently lit. For example, by interpolating and/or extrapolating from the measured brightness levels, the device determines a brightness distribution as an array of values, each value quantifying a brightness levels at different locations on the display, wherein the number of values exceeds the number of measured brightness levels.

For an embodiment, reference brightness distributions are mapped to different sets of luminosities for the lighting elements 204. This is done empirically under controlled conditions, for example, during the manufacturing and testing of an electronic device. Systematically, single known lighting elements 204 are turned off in turn while the other lighting elements 204 remain on, and in each case, a resulting reference brightness distribution is determined. Additional reference brightness distributions are measured and tabulated for different numbers of lighting elements 204 that are turned off in different combinations. The same is done for lighting elements 204 that are dimmed, simulating the effect of damaged lighting elements 204 that are operating below nominal tolerances. In this way, one or more brightness tables are compiled from the reference brightness distributions that allow measured brightness distributions (determined during normal operation of a device) to be mapped to sets of one or more lighting elements that are not outputting their intended luminosity. During normal operation, the device 100 determines which lighting elements 204 are radiating insufficient light or no light by comparing a measured brightness distribution to the empirically determined brightness tables. In a further embodiment, it is possible to extrapolate or interpolate from the brightness tables which lighting elements are not operating correctly given a measured brightness distribution that does not exactly match any single brightness table.

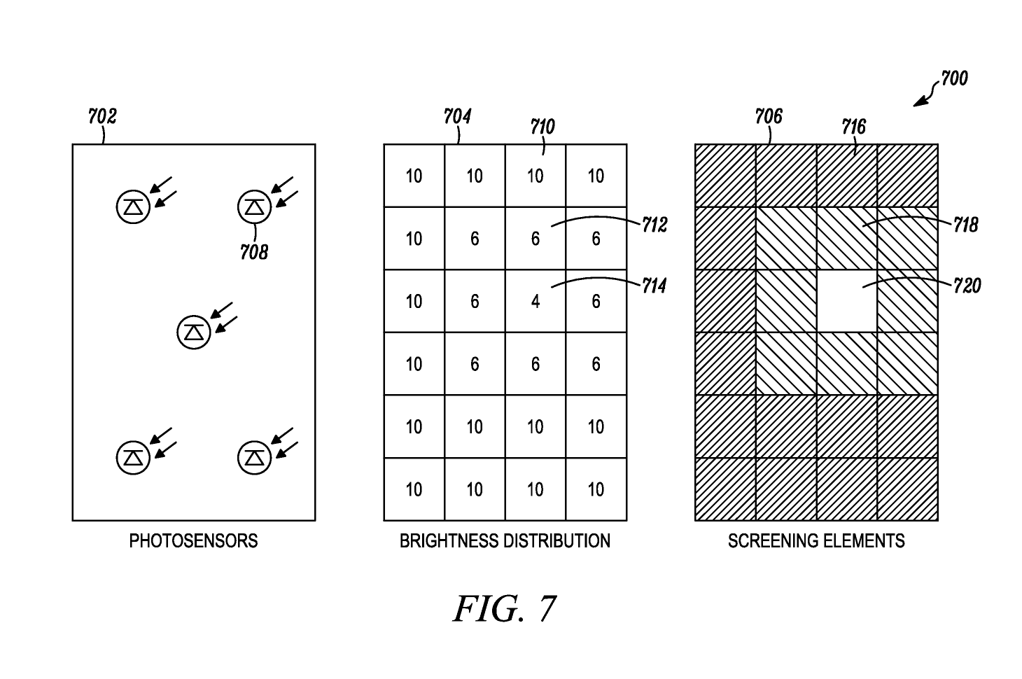

For another embodiment, lighting solutions are empirically established for different insufficiencies in backlighting. For example, while one lighting element 204 is turned off to simulate it not functioning, the luminosities of the remaining lighting elements 204 and/or the transmittances of screening elements 208 are adjusted to compensate in a way that results in reproducing more optimal or the most optimal lighting condition possible given the lighting insufficiency. For a nonfunctioning lighting element 204, the solution might involve increasing the luminosities of neighboring lighting elements 204 to sufficiently illuminate a portion of the display 202 above the nonfunctioning lighting element 204. Moreover, the solution might include making one or more screening elements 208 above the nonfunctioning lighting element 204 more transparent while making the screening elements above the lighting elements 204 with increased luminosities less transparent. The net effect is to reestablish uniform or substantially uniform lighting over the viewable area of the display 202. A device operating in accordance with the present teachings can, thus, determine a measured brightness distribution, map the brightness distribution to a brightness table, and identify and implement a lighting solution based on the mapping. A further description of an example of determining a brightness distribution for use in determining transmittance values for the screening elements 208 is provided later with reference to FIG. 7.

For the embodiment shown at 300, the LC layer 310 operates together with the first 308 and second 312 polarizing layers to perform the functionality of the screening element 208. The polarization axes of the first 308 and second 312 polarizing layers are perpendicular to one another. Light emitted by the lighting elements 204 is linearly polarized as it passes through the first polarization layer 308. This linearly polarized light is incident on the LC layer 310, which, for an embodiment, represents a thin film of a twisted nematic liquid crystal that is circularly birefringent. The LC layer 310 is optically active and able to cause a rotation of the polarization of the linearly polarized light passed by the first polarization layer 308. Where the LC layer 310 rotates the polarization of the linearly polarized light by 90 degrees, the light is aligned with the polarization axis of the second polarization layer 312 and is fully passed. Where the LC layer 310 does not rotate the polarization of the linearly polarized light, the polarization remains perpendicular to the polarization axis of the second polarization layer 312 and the linearly polarized light is blocked. The amount by which the LC layer 310 rotates the polarization for linearly polarized light is controlled by electric fields applied to different areas for the LC layer 310.

The LC layer 310 is divided into a plurality of areas, with each area representing a screening element of the screening elements 208. A thin-film transistor (TFT) for each area is used to control the charge, and thus the electric field, applied to each area of the LC layer 310. In a first embodiment, each area representing a screening element 208 becomes increasingly more transparent (less opaque) with the strength of the electric field applied to the area. In a second embodiment, each area representing a screening element 208 becomes increasingly more opaque (less transparent) with the strength of the electric field applied to the area. In a third embodiment, the electric field applied to an area of the LC layer 310 representing a screening element 208 is quantized into 16 discreet levels. In a fourth embodiment, the electric field is quantized into 256 discreet levels. For an alternative embodiment, the polarization axis of the second polarization layer 312 is piecewise adjustable on individual areas that represent the screening elements 208.

The cover layer 314, which is typically glass, is added to the front of the display 202. The cover layer 314 adds structural rigidity to the display 202 and protects the more delicate components lying underneath. One or more coatings may be used on the cover layer 314 to resist scratching and/or minimize glare from reflected light. For a particular embodiment, the cover layer 314 is configured to operate as a touch screen to receive user input that is processed by the processing element 212.

Returning to FIG. 2, the processing element 212 and the display controller 214 control the adjustments made to the display 202. The processing element 212 comprises the arithmetic logic and control circuitry necessary to perform the digital processing, in whole or in part, for the electronic device 100 to selectively adjust the backlighting brightness and/or transmittance of the display 202. For one embodiment, the processing element 212 represents the primary microprocessor, also referred to as a central processing unit (CPU), of the electronic device 100. For example, the processing element 212 can represent the application processor of a smartphone. In another embodiment, the processing element 212 is an ancillary processor, separate from the CPU, wherein the ancillary processor is dedicated to providing the processing capability, in whole or in part, needed for the system elements 200 to perform at least some of their intended functionality.

The display controller 214, under the control of the processing element 212, controls the functionality of the display 202 as described herein. In particular, the display controller 214 controls the luminosities of individual lighting elements 204. For an embodiment, the display controller 214 adjusts luminosities for individual lighting elements 204 by independently controlling duty cycles for individual sets of lighting elements 204. For example, under the control of the display controller 214, the lighting elements of a first set of lighting elements operate with a first duty cycle while the lighting elements of a second set of lighting elements operate with a second duty cycle that is different from the first duty cycle. As used herein, a set is defined as having one or more elements. In a further example, the display controller 214 controls the lighting elements 204 so that each lighting element operates with a different duty cycle.

In another embodiment, the display controller 214 controls the transmittance of the individual screening elements 208. For example, under the control of the display controller 214, the screening elements of a first set of screening elements operate with a first transmittance while the screening elements of a second set of screening elements operate with a second transmittance that is different from the first transmittance. In a further example, the display controller 214 controls the screening elements 204 so that each screening element operates independently of the others with a different transmittance.

For one embodiment, the display controller 214 controls both the luminosities of the lighting elements 204 and the transmittances of the screening elements 208 for a single electronic device with a display. In an alternative embodiment, the display controller shown at 214 is a logical component of a device that represents two or more physical display controllers that perform different functions. One display controller, for example, controls the luminosities of the lighting elements 204, while another display controller controls the transmittances of the screening elements 208.

The memory 216 provides temporary storage of electronic data used by the processing element 212 in performing its functionality. For one embodiment, the memory 216 represents volatile and/or non-volatile memory used by the processing element 212 to cache data. For a particular embodiment, the memory 216 represents volatile random access memory (RAM). For other embodiments, the memory 216 represents one or more non-volatile magnetic (e.g., hard drive) or solid state (e.g., flash memory) storage devices.

The power supply 210 supplies electric power to the device elements, as needed, during the course of their normal operation. The power is supplied to meet the individual voltage and load requirements of the device elements that draw electric current. The power supply 210 also powers up and powers down a device. For a particular embodiment, the power supply includes a rechargeable battery.

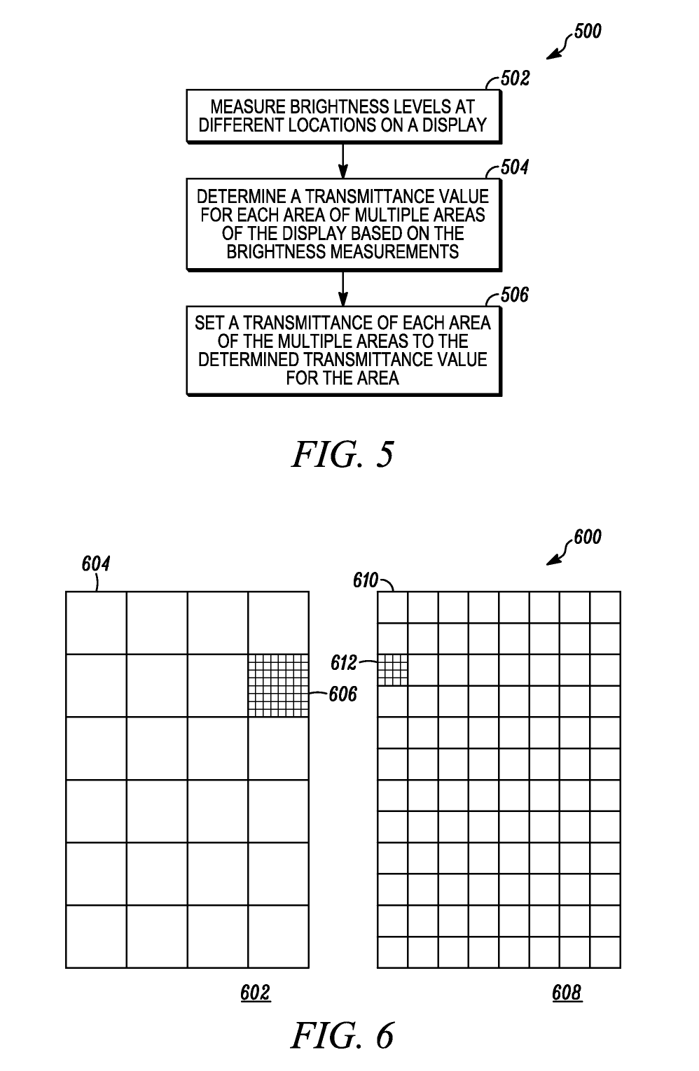

We turn now to a detailed description of the functionality of the device 100 and the device elements shown in FIGS. 1, 2, 3, and 4 at 102, 200, 300 and 400, respectively, in accordance with the teachings herein and by reference to the remaining figures. FIG. 5 is a logical flow diagram illustrating a method 500 performed by a device, taken to be device 100 for purposes of this description, for setting a transmittance for each of multiple areas of the display 102. The method includes the device 100 measuring 502 brightness levels at different locations on the display 102. For an embodiment, the device 100 makes the measurements using the photosensors 206. Based on the brightness measurements, the device 100 determines 504 a transmittance value for each of multiple area of the display 102. The device then sets 506 the transmittance of each area of the multiple areas to the determined transmittance value for the area.

Turning momentarily to FIG. 6, areas of the display 102 and the relationship between areas of the display 102 and the screening elements 208 are described in detail. As used herein, an area of a display is a two-dimensional portion of the display that includes a set of screening elements such that all the screening elements included in the area are set to the same transmittance value independent of the transmittance value set for other areas of the display 102. More specifically, FIG. 6 shows two schematic diagrams at 600 in which a viewable portion of the display 102 is divided into different numbers of areas. At 602, the display 102 is divided into 24 areas 604, while at 608, the display 102 is divided into 96 areas 610. Each area shown at 602 includes a set of 64 screening elements, as shown at 606. If the screening elements 208 of the display 102 are of fixed size, then dividing the display into a greater number of smaller areas results in fewer screening elements 208 per area. This is illustrated at 608 with an area 612 showing a set of 16 screening elements.

In a particular embodiment, the display 102 is divided into as many areas as there are screening elements 208 such that each area includes a set of exactly one screening element. In other embodiments, the size and shape of each area, and therefore the number of screening elements included in each area, varies from one area to the next over the viewable portion of the display 102.

Returning to FIG. 5, the measuring 502 of the brightness levels at different locations on the display 102 is performed by the photosensors 206 during the operation of the device 100. During the operation of the device 100 means while the device 100 is being actively used to perform a task for which it was designed. This includes the device operating in a power-savings mode while only a portion of the display is active. For example, while a user is browsing the Internet on the device 100, the photosensors 206 measure 502 brightness levels that determine a measured brightness distribution. From the measured brightness distribution, the processing element 212 of the device 100 determines 504 a transmittance value for each area of the multiple areas of the display 102.

In one embodiment, the processing element 212 maps the measured brightness distribution to a reference brightness distribution by comparing the measured brightness distribution to a brightness table of empirically tabulated data. A match between the measured brightness distribution and a reference brightness distribution is associated with a lighting solution that includes transmittance values to which the screening elements for different areas of the display 102 are set 506. As used herein, a match means agreement between the measured brightness distribution and a reference brightness distribution that was empirically determined. Because the set of empirically determined reference brightness distributions is limited (i.e., finite), a match need not, and likely will not, be exact. A measured brightness distribution is “matched” to the reference brightness distribution with which it has the closest agreement or highest degree of similarity.

For a particular embodiment, the lighting solution additionally defines the number, size, and shape of the areas into which the display 102 is divided. For a particular embodiment, the lighting solution is realized by a look-up table which is stored in memory 216 and to which the processing element 212 has access. The processing element 212 communicates the lighting solution, which includes a plurality of transmittance values, to the display controller 214, which, in turn, creates new areas (in embodiments for which the areas are adjusted) and sets 506 the transmittance for the screening elements 208 in accordance with the transmittance values.

For one embodiment, each area, e.g., 604, 610, of the multiple areas of the display 102 comprises a set of screening elements 208, wherein electronically setting transmittance for each area of the multiple areas comprises, for each area, electronically setting 506 a transmittance for each screening element for the area to the same transmittance value, which was determined 504 for that area. For this embodiment, the processing element 212 determines 504 only one transmittance value for an area of the display 102, which is used to electronically set 506 the transmittance for every screening element in the area. As used herein, a device electronically setting a transmittance for a screening element means that the device sets the transmittance using an electronic component of the device. For instance, the display controller 214, which for an embodiment includes at least one integrated circuit (IC), sets the transmittance for a screening element under the control of the processing element 212. In another embodiment, a set of screening elements 208 for each area of the multiple areas of the display 102 contains only a single screening element 208, and each transmittance value of the plurality of transmittance values determined 504 by the processing element 212 is used to electronically set 506 the transmittance of a different screening element 208.

For a further embodiment, a set of screening elements 208 for each area of the multiple areas contains a group of screening elements 208, and each transmittance value of the plurality of transmittance values determined 504 by the processing element 212 is used to electronically set 506 the transmittance of a different group of screening elements 208. For such an embodiment, different groups of one or more screening elements belonging to the same area of the display 102 can be set to different transmittances.

For some embodiments, the number of screening elements 208 or the size of an area for which the screening elements 208 are all set to the same transmittance value is based on the resolution of the measured brightness distribution, which, in turn, depends on, in whole or in part, the number of photosensors 206 used to measure the brightness levels. The exact size and position for a portion of the display 102 that is insufficiently lit is determined with greater accuracy when using more photosensors 206.

When only two photosensors 206 are used, one for each side of the display 102, for example, resolution of the brightness distribution is low and the only accurate inference that can be drawn from it is that the left side of the display 102 is not as bright as the right side. In this case, the processing element 212 might implement a lighting solution that divides the display 102 into two areas, one for each side of the display 102, and that uses a transmittance value for the left side of the display 102 that is higher (more transparent) than the transmittance value for the left side of the display 102.

Conversely, when many photosensors 206 are distributed across the display 102 to measure brightness levels, the resulting brightness distribution has better resolution. Dim areas of the display 102 are determined with greater quantitative and spatial precision. Therefore, the corresponding look-up table with the lighting solution provides more transmittance values for a larger number of display areas. With a sufficient number of photosensors 206 to determine a highly accurate brightness distribution, a more complex look-up table provides a lighting solution that has a separate transmittance value for each of the screening elements 208 used in the display 102.

FIG. 7 shows a sequence of three schematic diagrams 702, 704, 706 at 700 that illustrate a method for adjusting screening elements of a display in accordance with some embodiments of the present teachings. For a particular embodiment, the diagrams 702, 704, 706 represent the display 102 of the device 100. More specifically, the diagram 702 shows 5 photosensors 708 at the locations at which they each measure a brightness level on the display 102. A measured brightness distribution is shown at 704 for the display 102, which is divided into 24 areas. At 706, a graphical representation of the screening elements 208 is shown with transmittances set in accordance with a lighting solution that is associated with the brightness distribution 704.

From the 5 brightness levels measured, respectively, by the photosensors 708 while the device 100 is operating, the processing element 212 determines 24 brightness levels that define the brightness distribution 704. The 24 numbers of the brightness distribution 704 represent quantitative values that indicate brightness levels for the display 102 at the different areas shown. Higher numbers indicate greater brightness relative to lower numbers.

In a first embodiment, a transmittance value determined for a first area of the multiple areas of the display 102 is higher when a lighting element 204 of the backlighting source for the display 102 that illuminates the first area is off relative to when the lighting element 204 is on. For example, a brightness level at 714 over a nonfunctioning (e.g., burned out) backlighting element 204 is “4.” The brightness level is not “0” because that area of the display 102 still receives some light from neighboring lighting elements 204. In neighboring areas, e.g., at 712, the brightness level is “6” because light from the nonfunctioning lighting element 204 no longer adds to the brightness of the neighboring areas. At sufficient distances from the nonfunctioning lighting element 204, the absence of light from the nonfunctioning lighting element 204 no longer has an affect on the brightness level. As a result, the brightness level at 710, and other locations two areas removed from a location 714, is “10.”

The screened areas shown at 706 represent the implementation of the lighting solution for the nonfunctioning lighting element 204. The lighting solution has three transmittance values, a high value, a medium value, and a low value, that correspond to the three brightness levels of the brightness distribution 704. For a first area 720 above the nonfunctioning lighting element 204, the transmittances for all the screening elements 208 is set to the high transmittance value. This allows the most light through where the display 102 is most dim. Conversely, for an area 716, and the other areas for which the brightness level is “10,” the transmittances for the screening elements 208 is set to the low transmittance value to reduce the amount of light allowed through the display 102 there. For the screening elements 208 within an area 718, and the other areas for which the brightness level is “6,” the transmittances for the screening elements 208 is set to the medium transmittance value. This process of selectively screening different areas of the display 102 that correspond to different brightness levels, due to uneven backlighting, allows the lighting of the display 102 to be uniform or substantially uniform, despite the uneven backlighting.

In a second embodiment, a transmittance value determined for a first area of the display 102 is higher when a luminosity of a lighting element 204 of the backlighting source that illuminates the first area is lower relative to when the luminosity is higher. As an example, the brightness level at 714 of “4” is over a lighting element 204 that has a low luminosity relative to the other lighting elements 204 of the display 102. While the dim lighting element 204 still functions, its light output is low given a duty cycle to which it is set. As before, the lighting solution involves more screening (e.g., lower transmittance value) where the brightness levels are high and less screening (e.g., higher transmittance value) where the brightness levels are low to achieve uniform lighting over the display 102.

In a third embodiment, determining, based on the measured brightness levels, a first brightness level for a first area of the display 102 and a second brightness level for a second area of the display 102, wherein a transmittance value determined for the first area of the display 102 is higher than a second transmittance value determined for the second area of the display 102 when the first brightness level is lower than the second brightness level. Taking the areas 720 and 718 as the first and second areas of the display 102, respectively, the brightness level of “4” indicated at 714 is less than the brightness level of “6” indicated at 712. Therefore, the transmittance value determined for the first area 720 is higher than the transmittance value determined for the second area 718, as indicated by the shading at 718 and the absence of shading at 720.

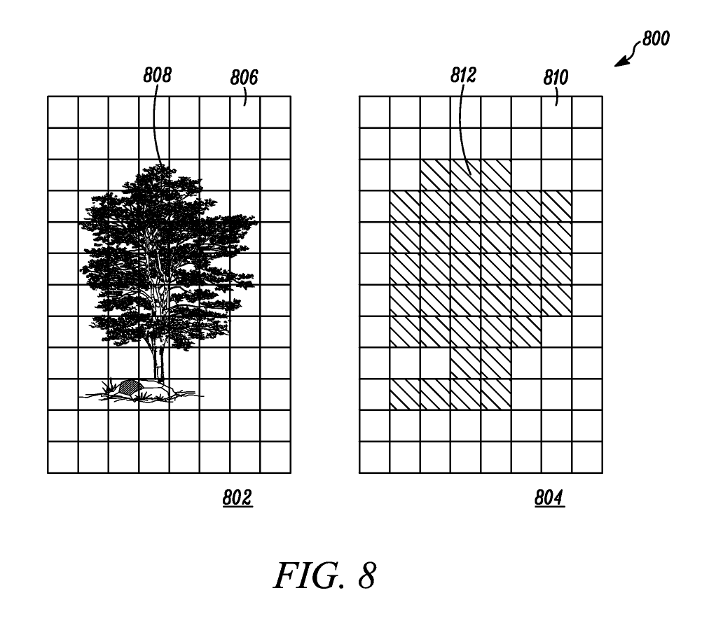

For other embodiments, determining a plurality of transmittance values for areas of the display 102 is further based on an image being displayed on the display 102. FIG. 8 illustrates such an embodiment at 800. Specifically, FIG. 8 shows a pair of schematic diagrams 802, 804 that represent the display 102 divided into 96 areas 806, 810, respectively. Displayed on the display 102 in diagram 802 is an image of a tree 808, which is darker than the background of the display 102. Evident from the diagram 802 is which of the 96 areas overlap the image 808.

Diagram 804 identifies two groups of areas, specifically, shaded areas 812 and areas 810 that are not shaded. Shaded areas 812 represent areas that mostly or completely overlap the tree 808, while the non-shaded areas 810 represent areas that are mostly or completely free of overlap with the tree 808. The screening elements 208 of the shaded areas 812 have their transmittances set to a transmittance value that is lower than the transmittance value to which the transmittances of non-shaded areas 810 are set. These settings help optimize the image quality of the tree 808 so that it appears darker than the background on which it is displayed.

For a specific embodiment, a first transmittance value determined for a first area of the display 102 coinciding with a darker portion of the image 808 is lower than a second transmittance value determined for a second area of the display 102 coinciding with a relatively lighter portion of the image 808. In this case, the shaded areas 812 do not collectively represent a single transmittance value, but rather multiple transmittance values. For example, an area overlapping a darker portion of the tree 808 has the transmittances of its screening elements 208 set to a transmittance value that is lower than a transmittance value to which the screening elements 208 of an area overlapping a lighter portion of the tree 808 are set. While not specifically shown in diagram 804, such an embodiment would be represented by variable shading among the areas 812.

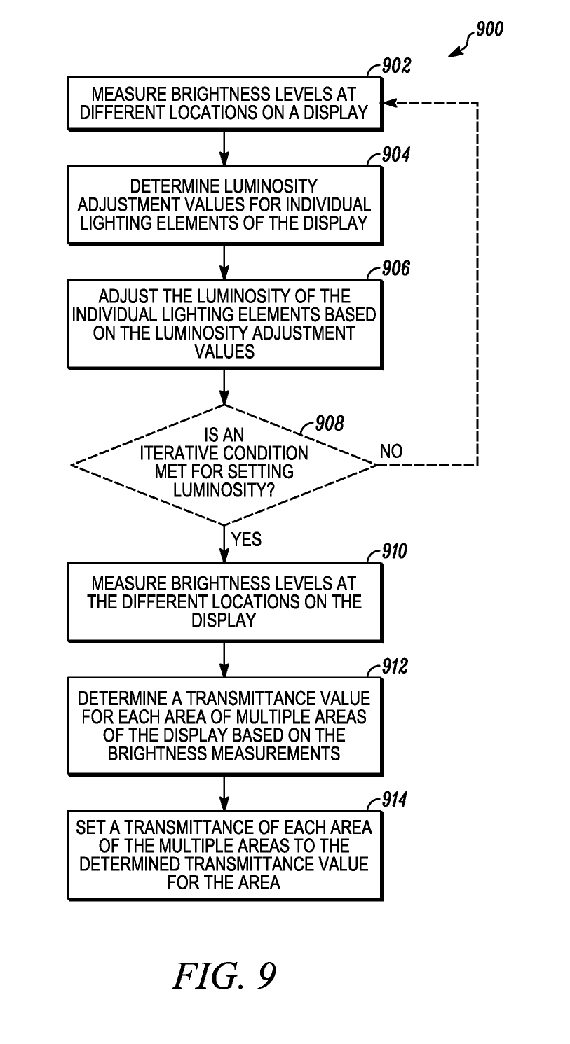

FIG. 9 is a logical flow diagram illustrating a method 900 for selectively adjusting the brightness of the display 102 by adjusting both the luminosities of the lighting elements 204 and the transmittances of the screening elements 208 in combination. Specifically, FIG. 9 shows the photosensors 206 measuring 902 brightness levels at different locations on the display 102. The measured brightness levels are communicated to the processing element 212, from a sensor hub (not shown), for example, using the bus 218. Based on the measured brightness levels, the processing element 212 determines 904 luminosity adjustment values for individually adjusting some or all of the lighting elements 204. A luminosity adjustment value, as used herein, is a quantitative measure used by an electronic device to change the luminosity (i.e., the light output) of one or more lighting elements within a display of the device. For example, a luminosity adjustment value might specify how much power to supply a lighting element or a duty cycle for the lighting element. Changing the duty cycle or the power supplied to a lighting element changes the luminosity of the lighting element.

Changing the luminosities of the lighting elements 204 is done to implement a lighting solution to, for instance, address insufficiencies in lighting for the display 102 or to improve lighting for the display 102 to provide better image quality and/or reduce power consumption. The lighting solution includes a set of luminosity adjustment values, and for an embodiment, the lighting solution is determined by the processing element 212 using a programmed algorithm held in memory 216. In an alternative embodiment, the processing element 212 determines the lighting solution from a look-up table using a brightness distribution determined from the measured brightness levels as described with reference to FIG. 3. The processing element 212 communicates the set of luminosity adjustment values over the bus 218 to the display controller 214, which adjusts 906 the luminosities of individual lighting elements 204 based on the luminosity adjustment values.

In a first embodiment, a lighting solution for a lighting element 204 with insufficient luminosity includes increasing the duty cycle for neighboring lighting elements 204. In a second embodiment, a lighting solution for a lighting element 204 with insufficient luminosity includes increasing the duty cycle for the lighting element 204 to increase its luminosity.

For a number of embodiments, adjusting the luminosities of individual lighting elements 204 within a backlighting source of the display 102 includes adjusting luminosities of a first set of lighting elements of the backlighting source to a first luminosity level and adjusting luminosities of a second set of lighting elements of the backlighting source to a second luminosity level that is different from the first luminosity level. In one embodiment, the luminosities of the first and second sets of lighting elements are adjusted based on an image being displayed on the display 102. For darker portions of an image, such as the image 808 in FIG. 8, less backlighting is needed relative to lighter portions of the image. Rather than, or in combination with, adjusting the transmittances of the screening elements 208 to selectively reduce the amount of backlighting reaching the front of the display 102, the luminosity levels for backlighting elements 204 that illuminate darker portions of the image 808 are reduced. For instance, the first luminosity level is lower than the second luminosity level when the first set of lighting elements 204 coincides with a darker portion of the image 808 and the second set of lighting elements coincides with a relatively lighter portion of the image 808.

In other embodiments, the device 100 selectively adjusts both the luminosities of the lighting elements 204 and the transmittances of the screening elements 208 to achieve a set of lighting criteria. Lighting criteria can include, but is not limited to, optimizing lighting of a display to improve image quality and/or for reduced power consumption. For particular embodiments, the transmittances of the screening elements 208 are adjusted iteratively until an iterative condition is met 908 before the transmittances of the screening elements 208 are adjusted. Thereafter, the photosensors 206 again measure 910 the brightness levels at different locations on the display 102, the processing element 212 determines 912 a transmittance value for each area of multiple areas of the display 102 based on the brightness measurements, and display controller 214 sets the transmittance of each area of the multiple areas of the display 102 to the determined transmittance value for the area. In a particular embodiment, the number of iterations performed in adjusting the luminosities of the individual lighting elements during the operation of the device 100 is limited by the processing power of the processing element 212. Too many iterations can load the processor 212 and cause the device 100 to be less responsive,

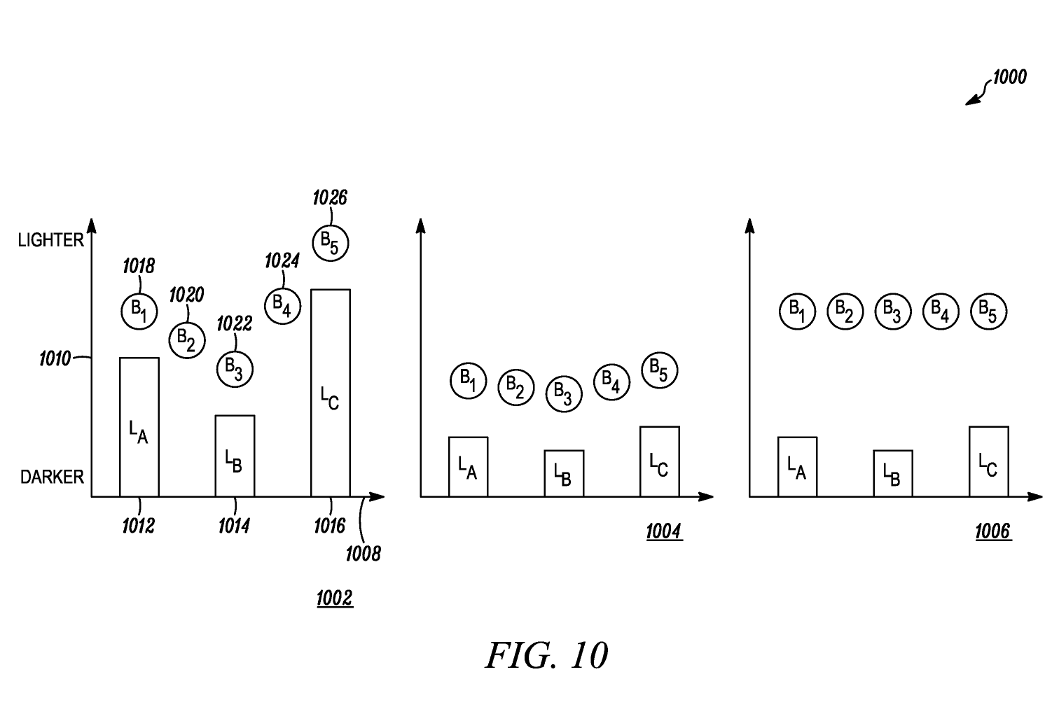

FIG. 10 shows a series of three logical diagrams at 1000 that illustrate a method for selectively adjusting both luminosity and transmittance for the display 102 in accordance with some embodiments of the present teachings. More specifically, logical diagrams 1002, 1004, 1006 represent “snapshots” for the process of adjusting the brightness of the display 102. For each snapshot, the height of rectangles 1012, 1014, 1016 on horizontal axis 1008 represent luminosity levels, L_{A}, L_{B}, and L_{C}, respectively, of three neighboring lighting elements designated as elements “A,” “B,” and “C.” Over the lighting elements A, B, C, circles 1018, 1020, 1022, 1024, 1026 represent brightness levels, B₁, B₂, B₃, B₄, B₅, respectively, above neighboring screening elements (not shown) for the display 102. The brightness levels B₂ 1020 and B₄ 1024 are indicated between the lighting elements A 1012, B 1014, and C 1016 because there are a greater number of screening elements 208 than lighting elements 204. A vertical axis 1010 for the snapshots 1002, 1004, 1006 represents a brightness level, with greater vertical distance from the intersection of the two axes 1008, 1010 representing increasing brightness.

The following example assumes the lighting criteria are uniform or substantial lighting across the front of the display 102. The device 100 measures 902 the brightness levels 1018, 1020, 1022, 1024, 1026 for the display 102 shown in the first snapshot 1002. The snapshot 1002 indicates the brightness levels 1018, 1020, 1022, 1024, 1026 are initially uneven because the luminosities 1012, 1014, 1016 of the underlying lighting elements A, B, and C are uneven. Due to, for example, age or defects in the lighting elements A, B, and C, their light outputs differ. The luminosity L_{C} 1016, for instance, is much greater than the luminosity L_{B} 1014. The device 102 determines 904 luminosity adjustment values and adjusts 906 the luminosities L_{A} 1012, L_{B} 1014, and L_{C} 1016. For an embodiment, measuring 902 the brightness levels B₁, B₂, B₃, B₄, and B₅ (1018-1026) and adjusting 906 the luminosities, L_{A}, L_{B}, and L_{C} (1012-1016) is done iteratively until an iterative condition is met 908, at which point, the lighting condition shown in the second snapshot 1004 is achieved. Iterative conditions include, but are not limited to, completing a predetermined number of iterations, or bringing a set of brightness levels within a threshold range of brightness levels.

For an embodiment, iteratively adjusting the luminosities of the lighting elements 204 is analogous to “coarse tuning” the brightness of the display 102, and thereafter adjusting the transmittances of the screening elements 208 is analogous to “fine tuning” the brightness of the display 102. As shown in the second snapshot 1004, the luminosities, L_{A}, L_{B}, and L_{C} are much more uniform than the luminosities shown for the first snapshot. As a result, the brightness levels B₁, B₂, B₃, B₄, and B₅ for the second snapshot 1004 are also more uniform, but not completely so. For instance, the luminosity L_{C} is still slightly greater than the luminosity L_{B}. Additionally, the luminosities, L_{A}, L_{B}, and L_{C} for the second snapshot 1004 are shown to be lower on average than the luminosities for the first snapshot 1002. The lower average luminosity helps extend battery life. To achieve sufficient brightness given the reduced average luminosity, the transmittances for the screening elements 208 are adjusted upward for the third snapshot 1006.

After the luminosities L_{A}, L_{B}, and L_{C} are adjusted, either iteratively or non-iteratively, the device 100 again measures 910 brightness levels at multiple locations on the display 102 to determine 912 transmittance values for the screening elements (not shown) that control the brightness levels B₁, B₂, B₃, B₄, and B₅. The device 100 fine tunes the brightness levels B₁, B₂, B₃, B₄, and B₅, making them uniform in the third snapshot 1006, by setting the transmittances of the corresponding screening elements to the transmittance values T₁, T₂, T₃, T₄, and T₅, respectively, where T₅<T₄<T₁<T₂<T₃. For a particular embodiment, the device 100 adjusts the luminosities so that the minimum luminosity level is just low enough so the device 102 can still achieve an objective brightness level by making the screening element 208 above the dimmest portion of the backlighting completely transparent. As illustrated at 1006, the minimum luminosity L_{B} occurs when the objective brightness level B₃ is achieved by making the screening element 208 corresponding to the brightness B₃ completely transparent. Using a minimum luminosity level as an iterative condition at 908 allows the device 100 to conserve power.

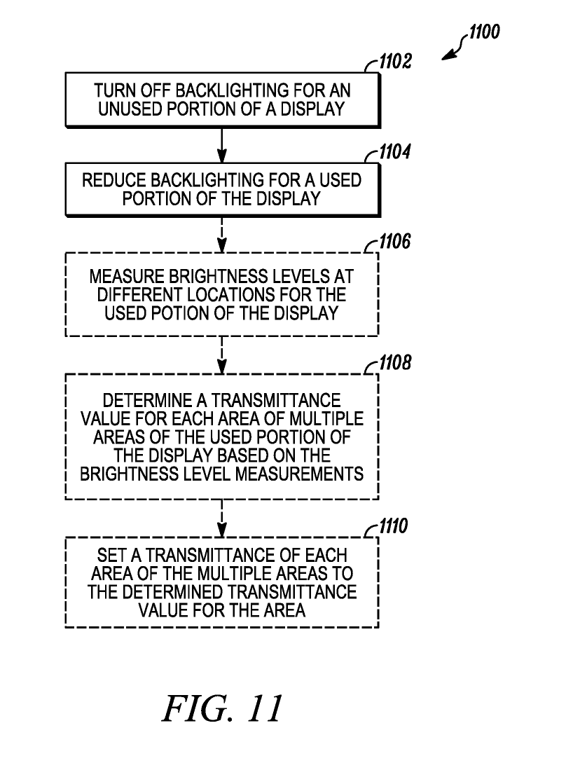

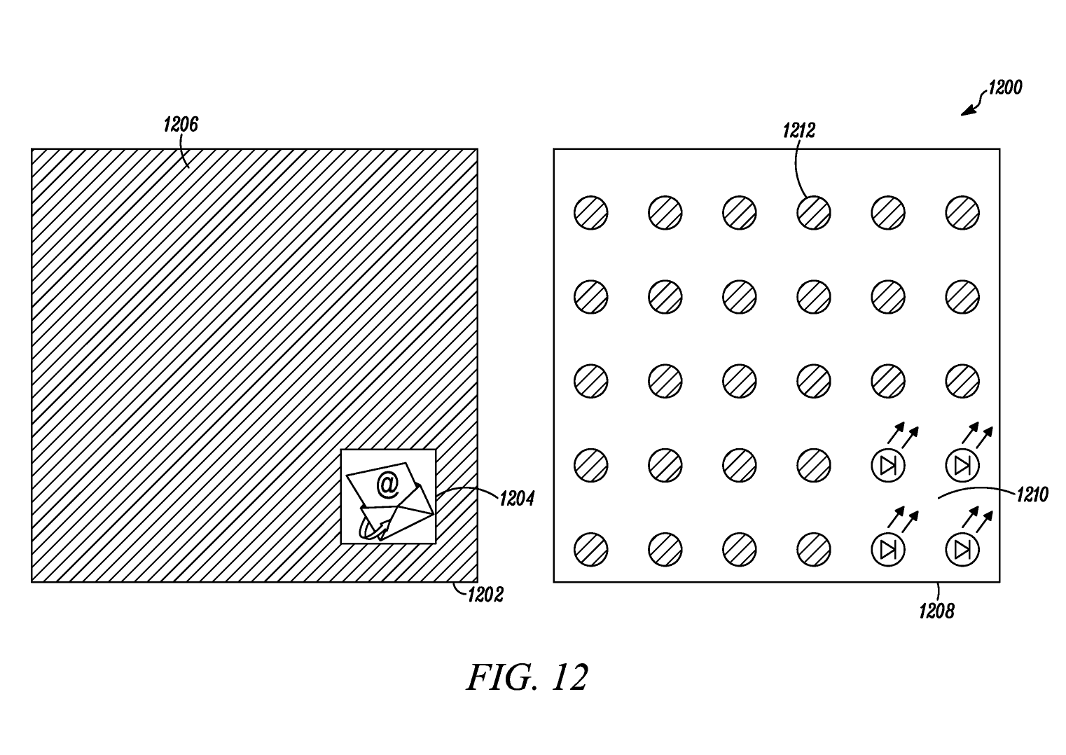

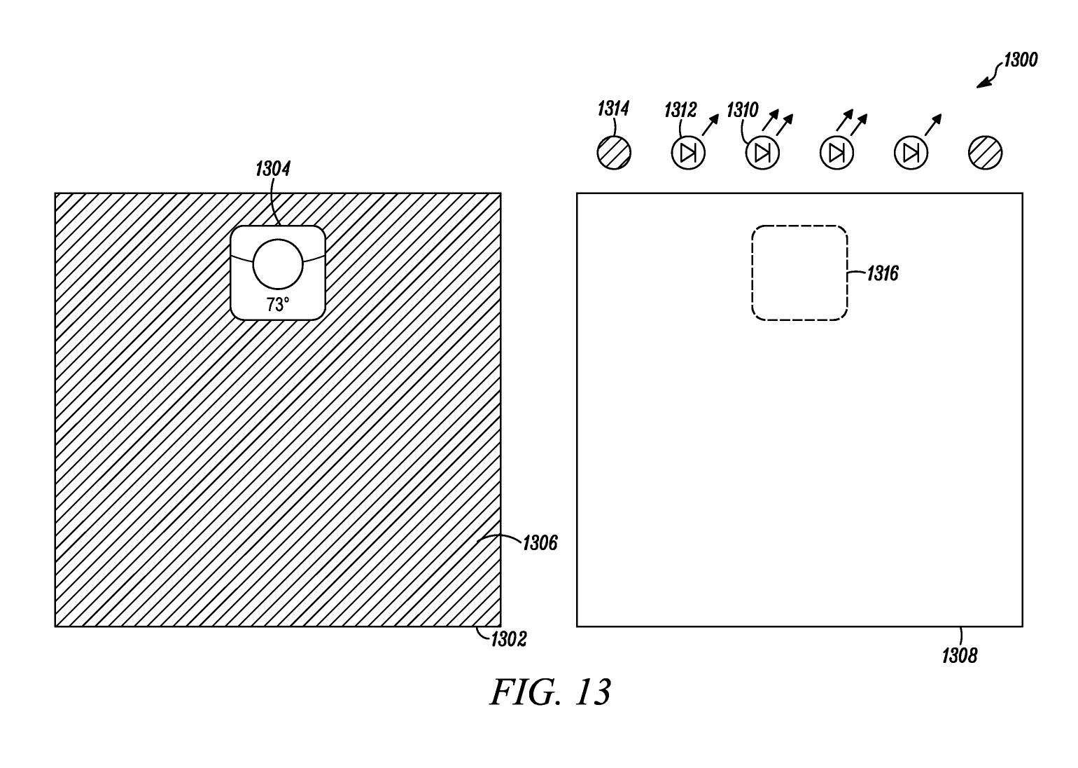

For a number of embodiments, a first set of lighting elements 204 coincide with an unused portion of the display 102, and adjusting the luminosities of the first set of lighting elements 204 comprises turning off the first set of lighting elements 204. Such embodiments are represented by a logical flow diagram 1100 illustrated in FIG. 11. Specifically, FIG. 11 shows the device 100 turning off 1102 backlighting for an unused portion of the display 102. The logical flow diagram 1100 also shows the device 100 reducing 1104 backlighting for a used portion of the display 102. For instance, a second set of lighting elements 204 coincide with a used portion of the display 102, and adjusting the luminosities of the second set of lighting elements 204 comprises reducing the luminosities of the second set of lighting elements 204. Embodiments that exemplify the turning off of lighting elements 204 for an unused portion of the display 102 are illustrated in FIGS. 12 and 13.

Shown in FIG. 12, at 1200 using diagrams 1202 and 1208, is a rectangular display area with array backlighting for which the backlighting is turned off with the exception of a notification area 1204 at the display's lower right corner. For an embodiment, the display area 1202 represents a display area for the display 102 of the device 100. As shown, the display 1202 is in a power-saving mode, such as when the device 100 is asleep. In another embodiment, turning off a portion of the display 102 depends on the user interface displayed. The backlighting for the majority of the display area 1202 is turned off, as indicated by shading at 1206. While the majority of the display area 1202 is dark, the notification area 1204 where the e-mail icon is shown still allows a user of the device 100 to receive alerts. The display area 1202 as shown at 1208 indicates an array of individual lighting elements distributed within the device's backlighting layer 304. Lighting elements 1212 corresponding to the unused portion 1206 of the display area 1202 are similarly shaded to indicate they are turned off. By contrast, lighting elements at 1210 remain on to illuminate the notification area 1204. While 30 LEDs are shown at 1208, further embodiments may include a greater or lesser number of lighting elements.

In an alternative embodiment, a portion of an edge backlighting module is turned off. FIG. 13 illustrates, at 1300, such an embodiment with two schematic diagrams 1302, 1308. The diagrams 1302, 1308 represent a display of a device, which for an embodiment is the display 102 of the device 100. The left diagram 1302 shows the lighting of the display while the right diagram 1308 shows the lighting elements of the display. A first portion 1306 of the display 1302 is unused, as is indicated by its the shading, while a used portion 1304 of the display 1302 is shown displaying current weather conditions. In the diagram 1308, the used portion of the display 1304 is indicated by and corresponds to a dashed outline 1316 and appears centered below lighting elements, which are arranged along an upper edge of the diagram 1308. The lighting elements 1310 and 1312 that illuminate the used portion 1316 of the display with the aid of a lightguide are shown turned on while the lighting elements 1314 at an outer edge of the display 1308, a portion of the display which is not used, are shown turned off.

In a further embodiment, the lighting elements 1310 directly illuminate the notification area 1316 and have the greatest luminosity, as indicated by the double arrows. The lighting elements 1314 align with the unused portion 1306 of the display and are therefore turned off, as indicated by the shading. When the device 100 measures the brightness levels of the display 1302, it determines that the brightness for the notification area 1316 is uneven. For example, the center of the notification area 1316 is brighter than its edges because the center receives light from all sides, whereas the edges do not receive light from neighboring lighting elements located within the unused portion of the display. To compensate, the device 100 turns on the lighting elements 1312 just outside the notification area and sets their luminosity to a level that is lower, as indicated by the single arrows, than the luminosity level for the lighting elements 1310. Transitioning from an abrupt cutoff to a gradual roll-off of luminosities for the lighting elements beyond the boundary of the notification area results in a more uniform light distribution across the notification area 1316. In a particular embodiment, lighting elements are positioned to better illuminate the notification area when lighting for the unused portion of the display 102 is turned off While six LEDs are shown at 1308, further embodiments may include a greater or lesser number of lighting elements.

Returning momentarily to FIG. 11, the method 1100 of turning off lighting elements for an unused portion of the display 102 optionally includes the device 100 adjusting the transmittances of the screening elements for the used portion of the display 102. Accordingly, the device 100 measures 1106, at each location of a plurality of locations on the used portion of the display 102, a brightness level produced by the backlighting source during operation of the electronic device, wherein the measuring is performed by a sensor at that location. The device 100 then determines 1108, based on the measured brightness levels, a plurality of transmittance values each specifying a transmittance for a different area of multiple areas of the used portion of the display and electronically sets 1110 the transmittance for each area of the multiple areas of the used portion of the display using the plurality of transmittance values.

Returning again to FIG. 13, the device 100 compensates for edge effects in the lighting of the notification area 1316 by setting transmittances for the screening elements at the edge of the notification area 1316 to a transmittance value that is higher than the transmittance value set for the screening elements at the center of the notification area 1316. Screening a portion of the light at the center of the notification area 1316 while allowing all the light to pass at the edges of the notification area 1316 allows for uniform lighting across the entire notification area 1316. By making the screening elements for the unused portion of the display 1306 completely opaque in combination with adjusting the luminosities of the lighting elements 1310 and 1312, crisp, well-defined edges are defined for the notification area 1316. By controlling individual lighting elements 204 and individual screening elements together 208, the size and shape of the used and unused portions of the display 102 are customizable while the display is operating in a power-savings mode.

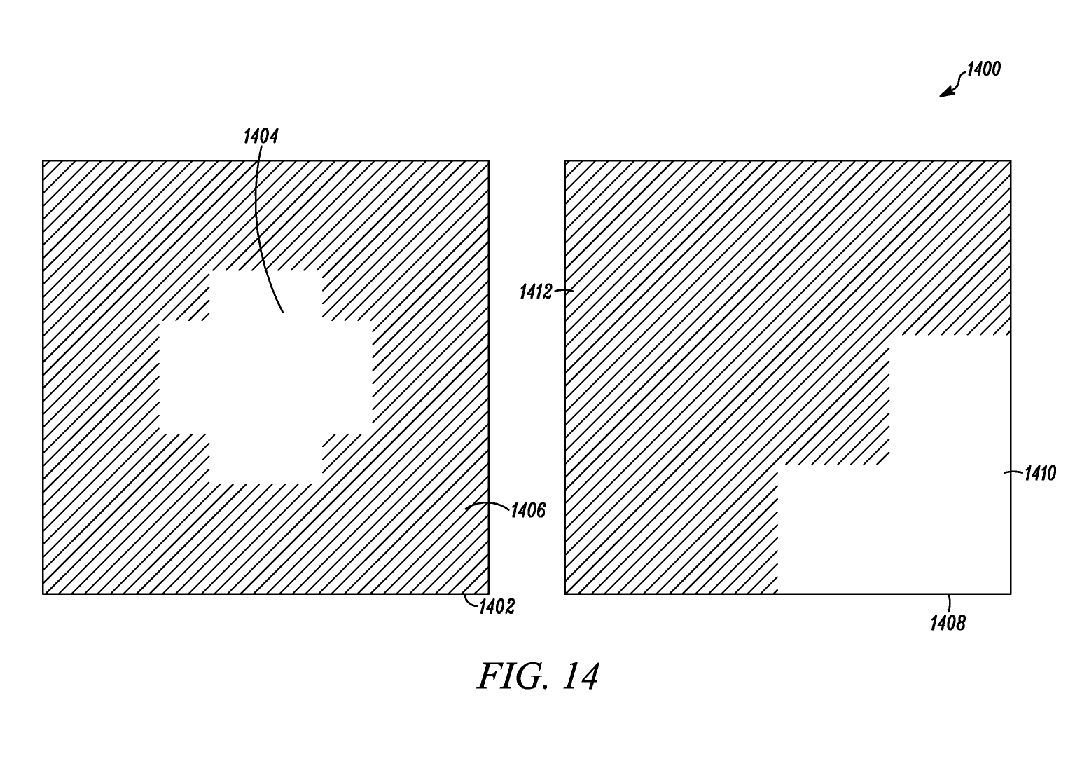

FIG. 14 shows a schematic diagram 1400 that illustrates two patterns 1404 and 1410 for a used portion of the display 102 while the display 102 is operating in a power-savings mode. The used portion 1404 of the display 102 shown at 1402 resembles a cross. Lighting elements that illuminate the used portion 1404 of the display 102 are turned on, while lighting elements that illuminate an unused portion 1406 of the display 102 are turned off The edges of the used portion 1404 of the display 102 are further defined by selectively controlling the transparency of the screening elements 208 to define the cross shown at 1402. As shown at 1408, the used portion 1410 of the display resembles an “L-shape.” Lighting elements for the used 1410 and unused 1412 portions of the display 102 are turned on and off, respectively. Selectively adjusting the transparency of the screening elements 208 allows for the specific “L-shape” shown. By individually controlling the lighting 204 and screening 208 elements of the display 102, a used portion of the display 102 can resemble both regular and irregular shapes of arbitrary size.

In one embodiment, no photosensors are used as the display 102 is divided into a used portion and an unused portion during operation in a power-savings mode. When real-time backlight monitoring is turned off or unavailable, due to damaged or absent photosensors, the processing element 212 of the device 100 uses predetermined backlighting settings compiled from empirical data obtained during a testing phase.

Benefits of the present disclosure include, but are not limited to, achieving optimal lighting of a display of an electronic device, in accordance with lighting criteria, by selectively controlling the luminosities of individual lighting elements that illuminate the display and/or selectively controlling the transmittances of individual screening elements that diminish the amount of light that illuminates the display. The lighting criteria can include, but is not limited to: producing uniform lighting for the display, producing an improved image on the display, and/or getting the best energy efficiency from the display.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method performed by an electronic device for adjusting transmittance for a display of the electronic device based on brightness produced by a backlighting source for the display, the method comprising:
measuring, at each location of a plurality of locations on the display, a brightness level produced by the backlighting source during operation of the electronic device, wherein the measuring is performed by a sensor at that location;
determining, based on the measured brightness levels, a plurality of transmittance values each specifying a transmittance for a different area of multiple areas of the display; and
electronically setting transmittance for each area of the multiple areas of the display using the plurality of transmittance values.

2. The method of claim 1, wherein each area of the multiple areas of the display comprises a set of screening elements, and wherein electronically setting transmittance for each area of the multiple areas comprises, for each area, electronically setting a transmittance for each screening element for the area to the same transmittance value, which was determined for that area.

3. The method of claim 2, wherein the set of screening elements for each area of the multiple areas contains a single screening element, and each transmittance value of the plurality of transmittance values is used to electronically set the transmittance of a different screening element.

4. The method of claim 2, wherein the set of screening elements for each area of the multiple areas contains a group of screening elements, and each transmittance value of the plurality of transmittance values is used to electronically set the transmittance of a different group of screening elements.

5. The method of claim 2, wherein the transmittance value determined for a first area of the multiple areas of the display is higher when a lighting element of the backlighting source for the display that illuminates the first area is off relative to when the lighting element is on.

6. The method of claim 2, wherein the transmittance value determined for a first area of the display is higher when a luminosity of a lighting element of the backlighting source that illuminates the first area is lower relative to when the luminosity is higher.

7. The method of claim 1 further comprising determining, based on the measured brightness levels, a first brightness level for a first area of the display and a second brightness level for a second area of the display, wherein a transmittance value determined for the first area of the display is higher than a second transmittance value determined for the second area of the display when the first brightness level is lower than the second brightness level.

8. The method of claim 1, wherein determining the plurality of transmittance values is further based on an image being displayed on the display of the electronic device.

9. The method of claim 8, wherein a first transmittance value determined for a first area of the display coinciding with a darker portion of the image is lower than a second transmittance value determined for a second area of the display coinciding with a relatively lighter portion of the image.

10. The method of claim 1 further comprising:
adjusting luminosities of a first set of lighting elements of the backlighting source to a first luminosity level; and
adjusting luminosities of a second set of lighting elements of the backlighting source to a second luminosity level that is different from the first luminosity level.

11. The method of claim 10, wherein the luminosities of the first and second sets of lighting elements are adjusted based on an image being displayed on the display.

12. The method of claim 11, wherein the first luminosity level is lower than the second luminosity level when the first set of lighting elements coincides with a darker portion of the image, and the second set of lighting elements coincides with a relatively lighter portion of the image.

13. The method of claim 10, wherein the first set of lighting elements coincide with an unused portion of the display, and adjusting the luminosities of the first set of lighting elements comprises turning off the first set of lighting elements.

14. The method of claim 13, wherein the second set of lighting elements coincide with a used portion of the display, and adjusting the luminosities of the second set of lighting elements comprises reducing the luminosities of the second set of lighting elements.

15. A method performed by an electronic device for adjusting a backlighting source for a display of the electronic device, the method comprising:
turning off lighting elements of the backlighting source for an unused portion of the display; and
reducing luminosities of lighting elements of the backlighting source for a used portion of the display.

16. The method of claim 15 further comprising:
measuring, at each location of a plurality of locations on the used portion of the display, a brightness level produced by the backlighting source during operation of the electronic device, wherein the measuring is performed by a sensor at that location;
determining, based on the measured brightness levels, a plurality of transmittance values each specifying a transmittance for a different area of multiple areas of the used portion of the display; and
electronically setting the transmittance for each area of the multiple areas of the used portion of the display using the plurality of transmittance values.

17. An electronic device configured to adjust transmittance for a display based on brightness produced by a backlighting source for the display, the electronic device comprising:
a display configured to display images, wherein the display includes:
a plurality of lighting elements configured to provide backlighting for the display;
a plurality of photosensors, wherein each photosensor is configured to measure a brightness level at a different location on the display during operation of the electronic device; and
a plurality of screening elements, wherein each screening element is configured to selectively screen the backlighting for a different area of multiple areas of the display based on a transmittance value for the screening element;
a processing element coupled to the plurality of photosensors, wherein the processing element is configured to determine, based on the measured brightness levels, a plurality of transmittance values and to communicate the plurality of transmittance values to a display controller; and
the display controller coupled to the plurality of screening elements and the processing element, wherein the display controller is configured to receive the plurality of transmittance values from the processing element and to electronically set the transmittance for each screening element of the plurality of screening elements based on the plurality of transmittance values.

18. The electronic device of claim 17, wherein the display is a liquid-crystal display, and each of the plurality of screening elements comprises a polarizing element.

19. The electronic device of claim 17, wherein the multiple areas of the display are configured so that:
each area comprises a single screening element of the plurality of screening elements, wherein the transmittance value for each screening element is determined independently from the transmittance values for the other screening elements; or
each area comprises multiple screening elements, wherein the multiple screening elements for the area are determined to have the same transmittance value.

20. The electronic device of claim 17, wherein:
the processing element is further configured to determine, based on the measured brightness levels, a set of luminosity adjustment values and to communicate the set of luminosity adjustment values to the display controller; and
the display controller is further coupled to the plurality of lighting elements and is further configured to adjust a luminosity of at least one lighting element of the plurality of lighting elements based on the set of luminosity adjustment values.
